(19) United States
(12) Patent Application Publication
(10) Pub. No.: US 2017/0046601 A1
(43) Pub. Date: Feb. 16, 2017

(54) SYSTEMS AND METHODS FOR VISUAL SENTIMENT ANALYSIS

(71) Applicant: The Trustees Of Columbia University In The City Of New York, New York, NY (US)

(72) Inventors: Shih-Fu Chang, New York, NY (US); Yan-Ying Chen, Sunnyvale, CA (US); Tao Chen, New York, NY (US)

(73) Assignee: The Trustees Of Columbia University In The City Of New York, New York, NY (US)

(21) Appl. No.: 15/220,565

(22) Filed: Jul. 27, 2016

Related U.S. Application Data
(63) Continuation of application No. PCT/US2015/013911, filed on Jan. 30, 2015.
(60) Provisional application No. 61/934,362, filed on Jan. 31, 2014.

(51) Int. Cl. G06K 9/62

(52) U.S. Cl. CPC G06K 9/6278; G06K 9/6296; G06K 2209/27

(57) ABSTRACT

Method for determining one or more viewer affects evoked from visual content using visual sentiment analysis using a correlation model including a plurality of publisher affect concepts correlated with a plurality of viewer affect concepts includes detecting one or more of the plurality of publisher affect concepts present in selected visual content, and determining, using the correlation model, one or more of the plurality of viewer affect concepts corresponding to the one or more of the detected publisher affect concepts. A method for determining one or more visual content to evoke one or more viewer affects using visual sentiment analysis is also provided.

### CROSS REFERENCE TO RELATED APPLICATIONS

This application is a continuation of International Patent Application No. PCT/US15/13911, filed Jan. 30, 2015, which claims priority to U.S. Provisional Application No. 61/934,362, filed on Jan. 31, 2014, each of which is incorporated by reference herein in its entirety.

STATEMENT REGARDING FEDERALLY-SPONSORED RESEARCH

This invention was made with government support under Agreement Number W911NF-12-C-0028 with the U.S. Defense Advanced Research Projects Agency (DARPA) under the Social Media in Strategic Communication (SMISC) program. The government has certain rights in the invention.

### BACKGROUND

Certain visual content, including and without limitation images and video, can be shared among users on the Internet, such as various forms of social media. Visual content can influence outcomes of social communication online, for example as a factor in attracting user interest and eliciting responses from users in social media platforms. For example, content conveying strong emotions can be used to make a message conveying such content viral, that is to generate a greater user interest and/or number of responses from users.

Certain techniques for sentiment analysis can be utilized to implement machines capable of mimicking certain human behavior. In this manner, high-level analysis of visual aesthetics, interestingness and emotion can be performed. Such analysis can attempt to map low level visual features to high-level affect classes. Nevertheless, such techniques can be challenging, due at least in part to semantic gaps and/or emotional gaps.

Other techniques for sentiment analysis can include use of mid-level representations, for example using Visual Sentiment Ontology and visual sentiment concept classifiers, including but not limited to, and as embodied herein, SentiBank (available from Columbia University). These techniques can discover a number of visual concepts related to certain primary emotions defined in psychology, and each visual sentiment concept can be defined as an adjective-noun pair (e.g., “beautiful flower,” “cute dog”), which can be chosen to combine the detectability of the noun and the strong sentiment value conveyed in adjectives. However, they can focus on affects expressed by content publishers, rather than emotions evoked in the viewer. While certain analysis of review comments by viewers can be performed, including mining opinion features in customer reviews, predicting comment ratings and summarizing movie reviews, such techniques can be performed without analyzing the content of the media being shared.

As such, there remains an opportunity for techniques to improve analysis of visual sentiment from visual content, including understanding of the influence of visual content on outcomes of social communication, as well as to predict such outcomes and generate responses to such visual content.

### SUMMARY

Systems and techniques for visual sentiment analysis and assistive image commenting are disclosed herein.

In one embodiment of the disclosed subject matter, techniques for visual sentiment analysis are provided. In an example embodiment, the disclosed subject matter provides a method for determining one or more viewer affects evoked from visual content using visual sentiment analysis. The method can use a processor in communication with a correlation model, the correlation model including a plurality of publisher affect concepts correlated with a plurality of viewer affect concepts. The method includes detecting one or more of the plurality of publisher affect concepts present in selected visual content, and determining, by the processor using the correlation model, one or more of the plurality of viewer affect concepts corresponding to the one or more of the detected publisher affect concepts.

In some embodiments, the method can further include providing the correlation model. The correlation model can include a Bayes model to characterize correlations between the plurality of publisher affect concepts and the plurality of viewer affect concepts. Providing the correlation model can further include smoothing the correlation model using collaborative filtering.

In some embodiments, the method can include obtaining the plurality of publisher affect concepts. The plurality of publisher affect concepts can be obtained from metadata associated with visual content in a visual content database. Additionally or alternatively, the plurality of publisher affect concepts can be obtained from visual analysis of visual content in a visual content database.

In some embodiments, the method can further include obtaining the plurality of viewer affect concepts. The plurality of viewer affect concepts can be obtained from social media comment data associated with visual content on a social visual content platform.

In some embodiments, the method can include generating one or more comments corresponding to the selected visual content based on the one or more determined viewer affect concepts. Generating the one or more comments can include forming one or more sentences using a relevance criterion of the one or more sentences with respect to the selected visual content. Additionally or alternatively, generating the one or more comments can include forming a plurality of sentences using a diversity criteria of a first sentence of the plurality of sentences compared to a subsequent sentence of the plurality of sentences. The method can include posting the one or more comments to a social media platform, or other suitable platforms, associated with the selected visual content.

In another example embodiment, the disclosed subject matter includes a method for determining one or more visual content to evoke one or more viewer affects using visual sentiment analysis. The method can use a processor in communication with a correlation model, the correlation model including a plurality of publisher affect concepts correlated with a plurality of viewer affect concepts. The method includes receiving one or more target viewer affect concepts of the plurality of viewer affect concepts, determining, by the processor using the correlation model, one or more of the plurality of publisher affect concepts correlated with the one or more target viewer affect concepts, selecting, by the processor in communication with a visual content database, one or more visual content corresponding to the one or more determined publisher affect concepts, and outputting, by the processor in communication with a display, the one or more visual content to the display.

In some embodiments, the method can further include providing the correlation model. The correlation model can include a Bayes model to characterize correlations between the plurality of publisher affect concepts and the plurality of viewer affect concepts. Providing the correlation model can further include smoothing the correlation model using collaborative filtering.

In some embodiments, the method can include obtaining the plurality of publisher affect concepts. The plurality of publisher affect concepts can be obtained from metadata associated with visual content in a visual content database. Additionally or alternatively, the plurality of publisher affect concepts can be obtained from visual analysis of visual content in a visual content database.

In some embodiments, the method can further include obtaining the plurality of viewer affect concepts. The plurality of viewer affect concepts can be obtained from social media comment data associated with visual content on a social visual content platform.

In some embodiments, the method can further include ranking the one or more visual content in order of likelihood of evoking the one or more target viewer affect concepts.

### BRIEF DESCRIPTION OF THE DRAWINGS

The accompanying drawings, which are incorporated and constitute part of this disclosure, illustrate some embodiments of the disclosed subject matter.

FIG. 1 is a diagram illustrating exemplary relationships between publisher affect concepts (PACs) and viewer affect concepts (VACs).

FIG. 2 is a diagram illustrating exemplary techniques for and applications of visual sentiment analysis according to the disclosed subject matter.

FIGS. 3A-3B are diagrams illustrating exemplary techniques for obtaining PACs and VACs, respectively, according to the disclosed subject matter.

FIGS. 4A-4B are diagrams illustrating exemplary techniques for obtaining predicted viewer affect concepts from an exemplary image.

FIG. 5 is a diagram illustrating exemplary techniques for selecting visual content to evoke a viewer affect. Five images are shown after each target viewer affect as exemplary recommendations.

FIGS. 6A-6D are diagrams illustrating exemplary techniques for generating suitable comments and associated viewer affect concepts from an exemplary image according to the disclosed subject matter. The upper comment is an exemplary comment recommended by the exemplary technique, and the lower comment is an examplary comment provided by a user.

FIG. 7 is a diagram illustrating an exemplary assistive comment system according to the disclosed subject matter.

FIG. 8 is a diagram illustrating an exemplary user interface for an assistive comment system according to the disclosed subject matter.

FIG. 9 is a detail view of Region 8 of FIG. 8, illustrating additional details of an exemplary assistive comment system according to the disclosed subject matter.

FIG. 10 is a diagram illustrating quality evaluation of machine-assisted comments from an exemplary assistive comment system, for purpose of illustration and confirmation of the disclosed subject matter.

FIGS. 11A-11D are diagrams illustrating additional details and evaluation of machine-assisted comments from an exemplary assistive comment system, for purpose of illustration and confirmation of the disclosed subject matter.

FIGS. 12A-12B are diagrams illustrating additional details and evaluation of machine-assisted comments from an exemplary assistive comment system, for purpose of illustration and confirmation of the disclosed subject matter.

FIGS. 13A-13F are diagrams illustrating exemplary machine-assisted comments from an exemplary assistive comment system FIGS. 13A-13C compared with user-generated comments FIGS. 13D-13F, for purpose of illustration and confirmation of the disclosed subject matter.

FIGS. 14A-14C are diagrams illustrating exemplary relevance control parameters for use with an exemplary assistive comment system according to the disclosed subject matter.

FIGS. 15A-15C are diagrams illustrating exemplary diversity metrics for use with an exemplary assistive comment system according to the disclosed subject matter.

Throughout the figures and specification the same reference numerals are used to indicate similar features and/or structures.

### DETAILED DESCRIPTION

According to aspects of the disclosed subject matter, systems and techniques for visual sentiment analysis include predicting viewer affects that can be triggered when visual content is perceived by viewers. Systems and techniques for visual sentiment analysis described herein can include correlating VACs, which can be associated with visual content, including visual content from a social media platform, with PACs associated with the visual content.

For purpose of illustration and not limitation, as embodied herein, visual content can include words, images, video, or any other visual content, and such content posted on a social media system can be referred to interchangeably as “visual content” or “social visual content.” For example, and as embodied herein, viewers can be provided an image tagged by the publisher as “yummy food,” and the viewers can be likely to comment “delicious” and “hungry.” Such viewer responses can referred to as “viewer affect concepts” (VACs) herein. Such VACs can be distinguished herein from “publisher affect concepts” (PACs). For example, with reference to the image described above, PACs can include the publisher tag “yummy food,” and additionally or alternatively, PACs can be determined from the image itself, as discussed further herein.

The systems and methods described herein are useful for analysis of visual sentiment from visual content. Although the description provides as an example the application of such techniques for implementing an assistive comment system, the systems and methods described herein are useful for a wide-variety of applications, including and not limited to, photo recommendation, evoked viewer affect prediction, among others. The structure and corresponding method of operation of and method of using the disclosed subject matter will be described in conjunction with the detailed description of the system.

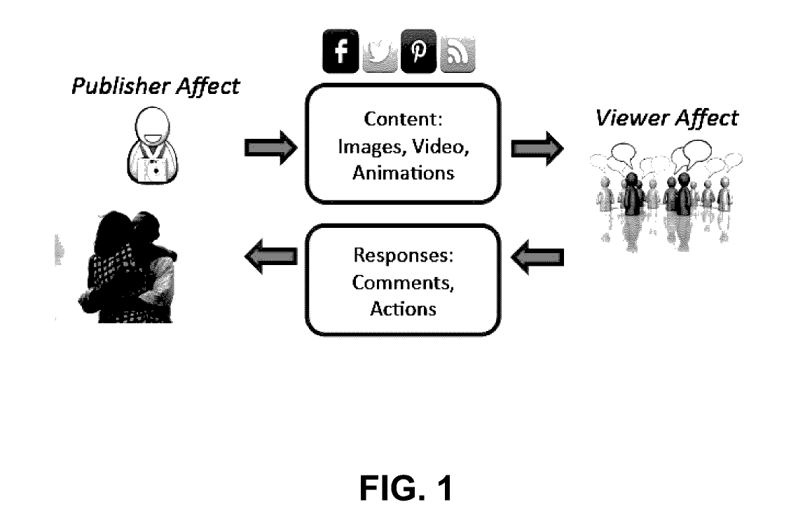

As shown for example in FIG. 1, and as embodied herein, distinctions between affects conveyed in an image intended by a publisher or poster of the visual content (publisher affect concepts or PACs) and the affects invoked on the viewer viewing the visual content (viewer affect concepts or VACs) are illustrated. For example, the picture of Mr. Obama in FIG. 1 can convey PACs by the publisher of “compassion” and “optimism,” and can invoke VACs of “trust” and “love” in certain viewers.

For purpose of illustration and not limitation, as embodied herein, VACs can be mined from real user comments associated with images in social media. Furthermore, an automatic visual based approach can be utilized to predict VACs, for example and without limitation by detecting PACs in the image content and applying statistical correlations between such the PACs and the VACs, as discussed further herein.

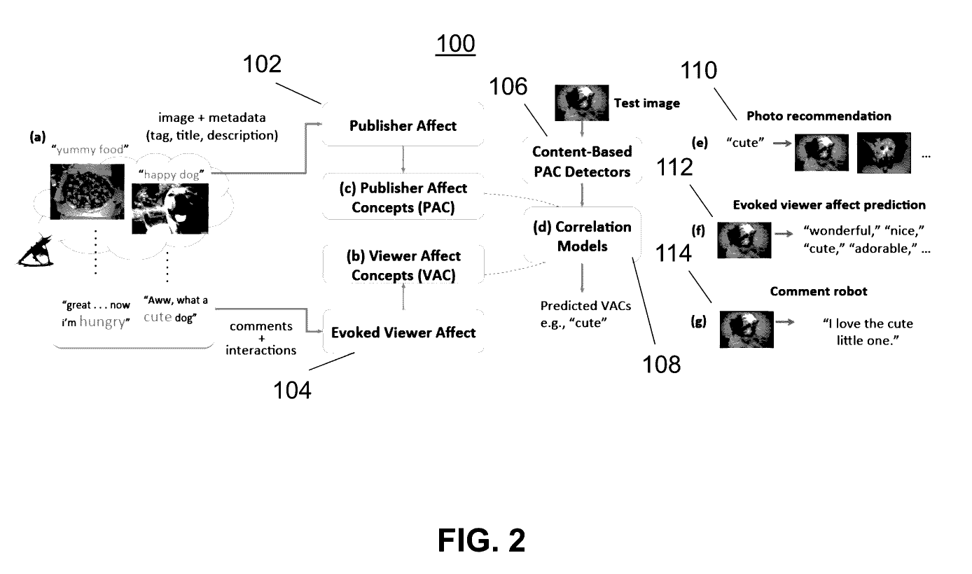

With reference to FIG. 2, exemplary techniques 100 for visual sentiment analysis are illustrated. As shown for example in FIGS. 2, at 102 and 104, a vocabulary, which can be suitable for describing visual sentiments from social visual content, can be determined or defined. For purpose of illustration and not limitation, as embodied herein, certain psychological emotions, can be adopted, for example, as search keywords to retrieve and organize online image data set for affective analysis. Affects seen in online social interactions, for example and withoult limitation, VACs “cute” and “dirty” in viewer comments of an image including a PAC “muddy dog,” can be more diverse than the basic ones defined in psychology. As shown for purpose of illustration in FIG. 2, at 102, PACs can be discovered from the image metadata (for example and without limitation, title, tags, and descriptions). At 104, VACs can be discovered, for example and without limitation, from the viewer comments associated with such emotional images. As such, basic emotional concepts can be expanded to include a more comprehensive vocabulary of concepts. A large number of PACs (for example and as embodied herein, about 1200) can be defined from images on a social media network, embodied herein using millions of images, as shown for example in 102. A large number of VACs (for example and as embodied herein, about 400) can be defined directly from million-scale real user comments associated with images on a social media network to represent the evoked affects in viewer feedback, as shown for example in 104. VACs can be represented as adjectives that occur frequently in social multimedia and reveal strong sentiment values.

Additionally, with continued reference to FIG. 2, correlations between PACs and VACs can be modeled. For purpose of illustration and not limitation, as embodied herein, statistical correlations can be measured by mining from surrounding metadata of images (i.e., descriptions, title, tags) and their associated viewer feedback (i.e., comments). As embodied herein, a Bayes probabilistic model can be developed to estimate conditional probabilities of seeing a VAC given the presence of PACs in visual content, as shown for example in 108. Additionally or alternatively, the mined correlations can be applied to predict VACs by automatically detecting PACs from visual content, as shown in 106, which can be performed without utilizing the metadata tags of the visual content.

For purpose of illustration and confirmation of the disclosed subject matter, a variety of applications can utilize visual sentiment analysis techniques described herein. For example and without limitation, at 110, techniques for visual sentiment analysis described herein can be utilized to recommend suitable visual content to achieve a target viewer affect. Additionally or alternatively, at 112, techniques for visual sentiment analysis described herein can be utilized to predict viewer affect responses to be evoked from selected visual content. Additionally, or as a further alternative, at 114, techniques for visual sentiment analysis described herein can be utilized to implement an assistive comment system to generate automated comments in response to visual content, for example to provide virtual reality social interaction. In these examples, techniques for visual sentiment analysis described herein can be utilized to enhance social interaction; for example, the assistive comment system can help users generate stronger and more creative comments, which can improve a user's social interaction on social networks.

According to aspects of the disclosed subject matter, exemplary datasets for obtaining VACs and modeling PAC-VAC correlations are provided. Viewer comments in social media can be utilized for obtaining VACs. Such viewer comments can be unfiltered, and thus preserve authentic views of the commenter, can provide a relatively large volume of comments available from major social media, and can be continuously updated, and thus be suitable for investigating trending opinions. For purpose of illustration and not limitation, to collect a dataset to be utilized to obtain VACs, an image or video hosting social media platform can be utilized.

TABLE 1
Exemplary Emotion Keywords and Number of Comments
emotion keywords (# comments)

ecstasy (30,809), joy (97,467), serenity (123,533)
admiration (53,502), trust (78,435), acceptance (97,987)
terror (44,518), fear (103,998), apprehension (14,389)
amazement (153,365), surprise (131,032), distraction (134,154)
grief (73,746), sadness (222,990), pensiveness (25,379)
loathing (35,860), disgust (83,847), boredom (106,120)
rage (64,128), anger (69,077), annoyance (106,254)
vigilance (60,064), anticipation (105,653), interest (222,990)

For example, and as embodied herein, an exemplary dataset can be collected. An image hosting social media platform can be searched with 24 keywords, which can correspond to eight primary emotion dimensions each having three varying strengths, such as defined in Plutchik's emotion wheel from psychology theories. Search results can include images from the image hosting platform containing metadata (tags, titles, or descriptions) relevant to the emotion keywords. The comments associated with the result images can be identified. For purpose of illustration, and not limitation, a number of comments for each emotion keyword is illustrated in Table 1, including about two million comments associated with 140,614 images. To balance the impact of each emotion on the search results, a subset of the comments, as embodied herein 14,000 comments for each emotion, resulting in 336,000 comments in total, can be used to obtain VACs.

Additionally, and as embodied herein, training data can be collected for example and without limitation, to model the correlations between PAC and VAC. The training data can utilize comments of the images that have PACs related to those defined in a PAC classifier library. A Visual Sentiment Ontology image dataset, such as Visual Sentiment Ontology (available from Columbia University) and the associated automatic classifier library of such PACs can be utilized in which associated image metadata (i.e., descriptions, titles and tags) includes at least one of a number of PACs, embodied herein as 1200 PACs, defined in the ontology, as discussed further herein. Comments associated with the image dataset can be identified to form the training data, which, as embodied herein, can contain about 3 million comments associated with 0.3 million images. On the average, for purpose of illustration and not limitation, as embodied herein, an image can have about 11 comments associated therewith, and a comment can include an average of about 15.4 words.

Correlations between intended emotion conveyed by publishers and the evoked emotion on the viewer side can be identified. For example and without limitation, such correlations can be modeled through a mid-level representation framework, that is, presenting the intended and evoked emotion in more fine-grained concepts, i.e., PACs and VACs, respectively. One or more PACs can be obtained from publisher contributed content, as discussed further herein, one or more corresponding VAC can be obtained from viewer comments, as discussed further herein, and a correlation model between the PACs and the VACs can be determined.

For purpose of illustration and not limitation, a number of sentiment concepts, embodied herein as 1200 sentiment concepts defined in a Visual Sentiment Ontology can be utilized as the PACs in visual content. As discussed herein, the sentiment concepts can be selected based on certain emotion categories and data collected from visual content in social media. Each sentiment concept can combine a sentimental adjective concept and a more detectable noun concept, for purpose of illustration and not limitation, “beautiful flower” or “stormy clouds.” The adjective-noun pair can thus turn a neutral noun like “dog” into a concept with strong sentiment like “dangerous dog,” which can make the concept more visually detectable compared to adjectives alone. The concept ontology can include a number of different emotions, as embodied herein represented as 24 emotional keywords discussed above, which can capture diverse publisher affects to represent the affect content.

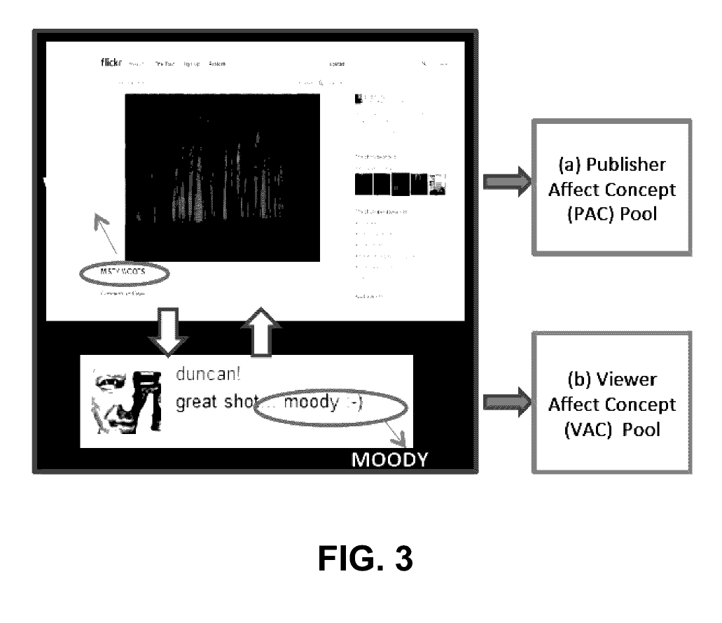

PACs can be found in publisher contributed metadata along with an image, as illustrated for example in FIG. 3A. For purpose of illustration and not limitation, one or more selection criteria can be used to find PACs from image metadata, for example, the frequency of usage of such PACs in image metadata on social networks and/or the estimated intensity of sentiment of the PACs, and/or any other suitable criteria.

Additionally or alternatively, PACs can be detected from the image content itself for example and without limitation, by classifiers utilizing image recognition techniques. For example, in a training stage, “pseudo ground truth” labels found in the image metadata can be utilized to detect presence of each PAC in the title, tags and/or description of each visual content. Such pseudo ground truth PAC data can be utilized as a training set to learn automatic classifiers for detecting PACs from visual content (for example and without limitation, by recognizing a PAC “colorful sunset” from an image).

Additionally or alternatively, for example in an active stage, visual-based PAC detectors can be utilized to measure the presence of each PAC in visual content, with or without any publisher contributed metadata. A PAC classifier library such as SentiBank, or any other suitable PAC classifier library, can be utilized, which can include a number of visual-based PAC detectors, embodied herein as 1200 PAC detectors, each corresponding to a PAC in VSO. The input to these detectors can include low-level visual features (for example and without limitation, color, texture, local interest points, geometric patterns), object features (for example and without limitation, face, car, etc.), and aesthetics-related features (for example and without limitation, composition, color smooth ness, etc.). As embodied herein, all of the 1,200 PAC detectors can have an F-score greater than 0.6 over a controlled test set.

For example, and as embodied herein, a test image dᵢ can be provided, and SentiBank detectors can be applied to estimate the probability of the presence of each PAC pₖ, which can be represented as P (pₖ|dᵢ). Such detected scores can be used to perform automatic prediction of VACs, as discussed further herein.

For purpose of illustration and not limitation, VACs can be obtained from viewer comments, as shown for example in FIG. 3B.

TABLE 2
Exemplary VACs of positive and negative sentiment obtained from
viewer comments.

| sentiment polarity | VACs |
|---|---|
| positive | beautiful, wonderful, nice, lovely, awesome, |
| | amazing, fantastic, cute, excellent, interesting, |
| | delicious, lucky, attractive, happy, adorable |
| negative | sad, bad, sorry, scary, dark, angry, creepy, difficult, |
| | poor, sick, stupid, dangerous, freaky, ugly, |
| | disturbing |

For example, and without limitation, systems and techniques for parsing observation data, a post-processing pipeline for cleaning noisy comments and selecting VACs based on certain criteria can be utilized.

Comments associated with visual content can contain rich but noisy text, with a relatively small portion of subjective terms. Adjectives can reveal higher subjectivity, which can be informative indicators about user opinions and emotions. As such, part-of-speech tagging can be applied to extract adjectives. Adjectives within a certain neighborhood of negation terms, for example and without limitation, “not” and “no,” can be excluded, which can avoid confusing sentiment orientation. Additionally or alternatively, hyperlinks and HTML tags contained in the comments can be removed, which can reduce influence by unsolicited messages or “spam.”

Sentimental and popular terms, which can be used to indicate viewer affective responses, can be emphasized. For example, and without limitation, the sentiment value of each adjective can be measured, for example using SentiWordNet, or any other suitable lexical sentiment analysis tool. The sentiment value can range from −1 (negative sentiment) to +1 (positive sentiment). The absolute value can be used to represent the sentiment strength of a given adjective. In this manner, adjectives with high sentiment strength (for example and without limitation, embodied herein as at least 0.125) and high occurrence frequency (for example and without limitation, embodied herein as at least 20 occurrences) can be retained. For purpose of illustration and not limitation, as embodied herein, a total of 446 adjectives can be selected as VACs. Table 2 illustrates exemplary VACs of positive and negative sentiment polarities, respectively.

For purpose of illustration and not limitation, as embodied herein, correlations between PACs, which can correspond to intended emotional concepts, and VACs, which can correspond to evoked emotional concepts, can be determined. For example and without limitation, as embodied herein, PACs can be obtained, as discussed herein, from descriptions, titles and tags of visual content (provided by publishers), and/or from visual content itself, and co-occurrences of VACs in comments of the visual content can be measured. As discussed herein, the interpretability of PACs can allow explicit description of attributes in visual content related to intended affects of the publisher. Noisy information can remain in such descriptions, yet the large scale observation data from social media networks, which can be periodically parsed and updated, can provide suitable data to identify relationships between PACs and VACs.

The pseudo ground truth PAC data described herein can be used to determine correlation between PACs and VACs. Such metadata can have a false miss error, that is, visual content without explicit labels of a PAC can still include content of the PAC. As such, a label smoothing technique can be utilized, as described herein, to at least partially address any false miss error.

Furthermore, and as embodied herein, Bayes probabilistic models can be applied and co-occurrence statistics determined from training data obtained from an image hosting social media platform can be utilized to estimate correlations between PACs and VACs. For example, and as embodied herein, a VAC vⱼ can be determined, and a number of occurrences of the VAC in the training data and its co-occurrences with each PAC pₖ over the training data θ can be obtained. A conditional probability P(pₖ|vⱼ) can then be determined by,

$$P ( {p}_{k} \vert {v}_{j} ; θ ) = \frac{{\sum }_{i = 1}^{\vert D \vert} {B}_{ik} P ( {v}_{j} \vert {d}_{i} )}{{\sum }_{i = 1}^{\vert D \vert} P ( {v}_{j} \vert {d}_{i} )} , \qquad ( 1 )$$

where Bᵢₖ can represent a binary variable indicating the presence/absence of pₖ in the publisher provided metadata of image dᵢ and |D| can represent the number of images. P(vⱼ|dᵢ) can be measured by the occurrence counting of vⱼ in comments of image dᵢ. Using correlations P(pₖ|vⱼ;θ), the likelihood of an image dᵢ having VAC vⱼ can be measured, as embodied herein, by multivariate Bernoulli formulation.

$$P ( {d}_{i} \vert {v}_{j} ; θ ) = {\prod }_{k = 1}^{\vert A \vert} ( P ( {p}_{k} \vert {d}_{i} ) P ( {p}_{k} \vert {v}_{j} ) ; θ ) + ( 1 - P ( {p}_{k} \vert {d}_{i} ) ) ( 1 - P ( {p}_{k} \vert {v}_{j} ; θ ) ) ) . \qquad ( 2 )$$

A can represent the set of PACs in SentiBank. P(pₖ|dᵢ) can be measured using the scores of SentiBank detectors, as discussed herein, which can estimate the probability of PAC Pₖ appearing in image dᵢ. As embodied herein, PACs can represent shared attributes between images and VACs, and can resemble a probabilistic model for content-based recommendation. As such, the posterior probability of VACs given a test image dᵢcan be measured using Bayes' rule,

$$P ( {v}_{j} \vert {d}_{i} ; θ ) = \frac{P ( {v}_{j} \vert θ ) P ( {d}_{i} \vert {v}_{j} ; θ )}{P ( {d}_{i} \vert θ )} . \qquad ( 3 )$$

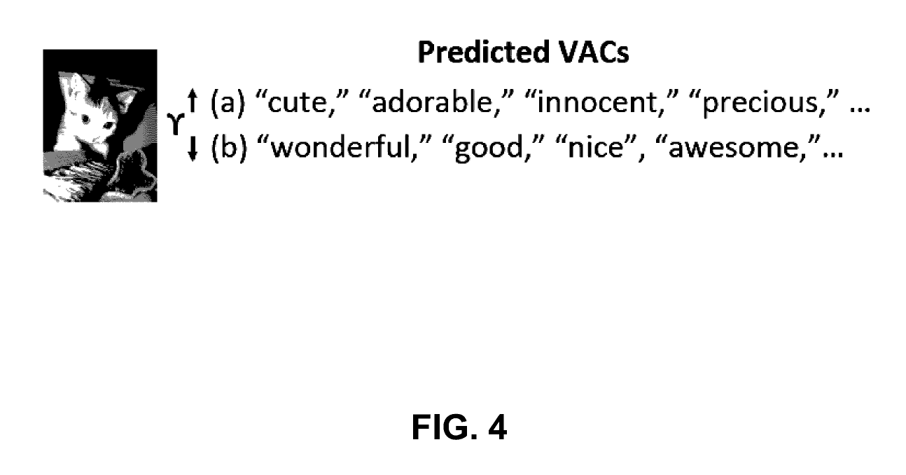

P (vⱼ|θ) can be determined by the frequency of VAC vⱼ appearing in the training data and P (dᵢ|θ) can be represented as being equal over images. P(vⱼ|θ) can indicate the popularity of the VAC vⱼ in social media. As shown for example in FIGS. 4A-4B, exemplary VACs can be ranked by content-based likelihood (FIG. 4A) and prior probability (FIG. 4B), γ value can adjust the influence of visual content on predicting the VACs, that is, the higher γ, the more influence image content has on the prediction. For example and without limitation, exemplary VACs with higher P(vⱼ|θ) for an exemplary visual content are shown in FIG. 4B. For purpose of comparison, P (dᵢ|vⱼ, θ) can represent relevance of the VAC vⱼ to the image content in dᵢ, illustrated as the VACs ranked by P(dᵢ|vⱼ, θ) in FIG. 4A. Different characteristics can be found in the predicted probability of VACs, and thus a relevance indicator γ can be included in the measurement of posterior probability to adjust the influence from visual content.

$$P ( {v}_{j} \vert {d}_{i} ; θ ) = \frac{{P ( {v}_{j} \vert θ )}^{1 - γ} {P ( {d}_{i} \vert {v}_{j} ; θ )}^{γ}}{P ( {d}_{i} \vert θ )} . \qquad ( 4 )$$

Eq. (4) can be utilized for certain applications. For purpose of illustration and not limitation, as embodied herein, visual content can be provided, and the most possible VACs can be determined from the posterior probability. For example, and as embodied herein, in VAC prediction, γ can be set to 0.5 to balance the impact from either side, as discussed further herein. For comment suggestion, the impact of varying γ value is discussed further herein.

Furthermore, and as embodied herein, missing associations or unobserved correlations between PACs and VACs can be addressed. For example, a PAC “muddy dog” can trigger the VAC “dirty,” but such viewer comments including this VAC can be missing for this PAC. Some PACs can share similar semantic meaning, for example and without limitation, “muddy dog” and “dirty dog.” As such, collaborative filtering techniques can be applied to fill potential missing associations. In this manner, matrix factorization can be utilized to discover latent factors of the conditional probability (P(pₖ|vⱼ) in Eq. (1)) and optimal factor vectors tⱼ, sₖ can be utilized for smoothing missing associations between PAC pₖ and VAC vⱼ. The matrix factorization formulation can be represented as min_{t,s} Σ_{k,j}(P(pₖ|vⱼ)−tⱼTsₖ))² . Non-negative matrix factorization can be utilized to provide smoothed associations having all non-negatives, which can correspond to the calculation in the probabilistic model. The approximated associations (P(pₖ|vⱼ) between PAC pₖ and VAC vⱼ can then be smoothed by tⱼTsₖ.

With the smoothed correlations, represented as P̂(pk|vj), and a viewer affect concept vj, the likelihood for an image di can thus be represented as,

$$P ( {d}_{i} \vert {v}_{j} ; θ ) = {\prod }_{k = 1}^{\vert A \vert} ( P ( {p}_{k} \vert {d}_{i} ) \hat{P} ( {p}_{k} \vert {v}_{j} ) + ( 1 - P ( {p}_{k} \vert {d}_{i} ) ) ( 1 - \hat{P} ( {p}_{k} \vert {v}_{j} ; θ ) ) ) . \qquad ( 4.1 )$$

For example and as embodied herein, all the computations can be conducted in the log-space, which can reduce or avoid floating-point underflow when calculating products of probabilities.

According to other aspects of the disclosed subject matter, techniques for visual sentiment analysis described herein can be utilized to recommend suitable visual content to achieve a target viewer affect. For a VAC vⱼ, a recommendation can be performed by ranking images over the likelihood P(dᵢ|vⱼ), as measured for example by eq. (4.1). For each VAC, for example and without limitation, as embodied herein, 10 positive images and 20 negative images can be randomly selected from the test database for evaluation. The ground truth of VAC for each image can be determined by whether the VAC can be found in the comments associated with this image. For example and without limitation, as embodied herein, if the VACs “nice,” “cute” and “poor” are found in the comments of an image, then the image can represent a positive sample for “nice,” “cute” and “poor” VAC image recommendation. The performance can be evaluated by average precision (AP) over a number of mined VACs, embodied herein as 400 VACs.

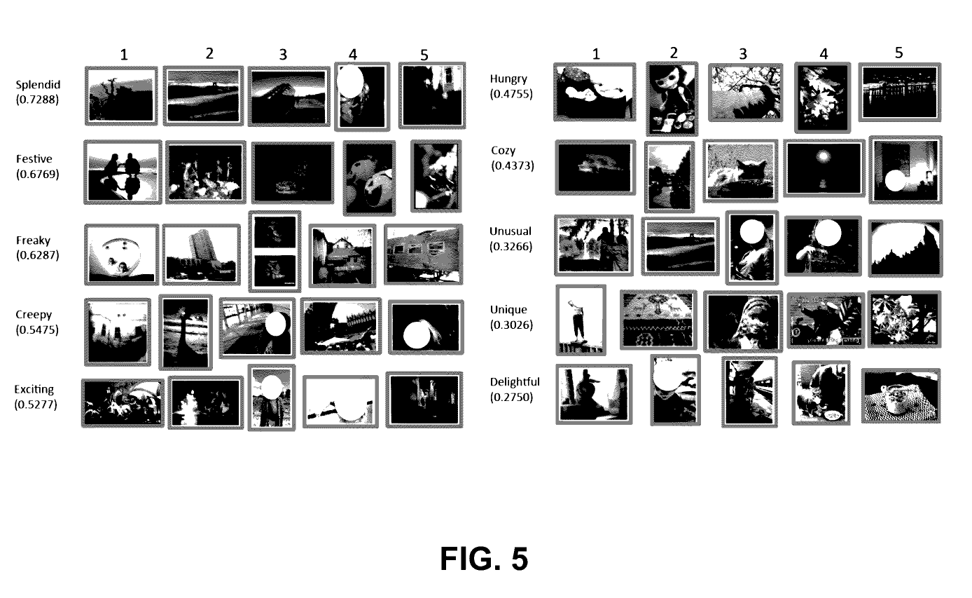

As shown, for example and without limitation, in Table 4, the mean value of the average precision of the 100 most predictable VAC can be about 0.5321. Mean AP can exceed 0.42 in the best 300 VACs, and can decrease to 0.3811 over the entire set of 400 VACs. FIG. 5 illustrates exemplary recommended images for exemplary target VACs. The images are ranked by likelihood using eq. (4.1) from more likely to less likely (1 to 5) and the sampled VACs are sorted by average precision, shown in parenthesis. As shown for example in FIG. 5, the most predictable VACs can have consistent visual content or semantics. For example, the images for “splendid” can be correlated with scenic views (e.g., 1, 2 and 3). By comparison, the VACs with less agreement among viewers (e.g., “unusual” and “unique”) can be considered less predictable. In FIG. 5, faces in each image are masked. Images associated with “festive” can tend to display warm color tones, which can suggest that viewers tend to have common evoked affects for certain types of visual content. Moreover, images containing more diverse semantics in visual content (e.g., “freaky” and “creepy”) can be recommended, due at least in part to obtaining PAC-VAC correlations from a large pool of image content with a large number of comments, as described herein.

TABLE 4
Performance of image recommendation for target viewer affects. Mean
Average Precision (MAP) values of the top 100, 200, 300, and entire
set of VACs.

top VACs

| | 100 | 200 | 300 | overall |
|---|---|---|---|---|
| MAP | 0.5321 | 0.4713 | 0.4284 | 0.3811 |

As discussed herein, comments associated with visual content can be considered sparse, that is, for example and without limitation, and as embodied herein, averaging 11 comments for each image and 15.4 words per comment, and can lead to missing associations. For example, with reference to FIG. 5, and as embodied herein, the top 1 and 2 recommended images for “delightful” include a smile, which likely evokes “delightful” affect. However, as embodied herein, the term “smile” was not included in the comments of the images, and thus can be considered as an incorrect prediction. In general, VACs without clear consensus among viewers (e.g., “unusual” and “unique”) can be considered less predictable.

According to aspects of the disclosed subject matter, techniques for visual sentiment analysis described herein can be utilized to predict viewer affect responses to be evoked from selected visual content. For example, and as embodied herein, this technique can be considered as an inverse of the techniques presented herein for image recommendation. for purpose of illustration and not limitation, as embodied herein, an image dᵢcan be provided, and a number of possible viewer affect concepts stimulated by image dᵢcan be predicted. A posterior probability of each VAC vⱼ can be determined by the probabilistic model in eq. (3). A greater posterior probability can indicate a greater likelihood of the VAC vⱼ being evoked by the given image dᵢ. For purpose of illustration and confirmation of the disclosed subject matter, the correlation between PACs and VACs described herein can be compared with a baseline using PACs only. In this manner, the PAC-only technique can predict the VACs found in comments of the other images with the most similar PAC detected from image content without considering PAC-VAC correlations.

Exemplary images can be selected from a database, as described herein, and each image can have comments including at least one viewer affect concept. For purpose of illustration, 2,571 example images were evaluated based on two performance metrics, overlap ratio and hit rate. As embodied herein, overlap ratio can indicate how many predicted VACs are covered by the ground truth VACs, and can be normalized by the union of predicted VACs and ground truth VACs.

$$overlap = \frac{\vert \{ groundtruthVACs \} ⋂ \{ predictedVACs \} \vert}{\vert \{ groundtruthVACs \} ⋃ \{ predictedVACs \} \vert} \qquad ( 5 )$$

For purpose of illustration and confirmation of the disclosed subject matter, as embodied herein, Table 5 illustrates the performance of viewer affect concept prediction given a new image. As shown for example in Table 5, the overlap ratio using PAC-VAC correlation (Corr) surpasses the baseline (PAC-only) with 20.1% improvement. Moreover, PAC-VAC correlation obtains superior hit rate and the hit rate of the top 3 predicted VACs. As such, a higher consistency of the predicted VAC and the ground truth VACs can be obtained.

TABLE 5
The performance of viewer affect concept prediction given a new image.

| method | PAC-only | Corr |
|---|---|---|
| overlap | 0.2295 | 0.4306 (+20.1%) |
| hit rate | 0.4333 | 0.6231 (+19.0%) |
| hit rate (3) | 0.3106 | 0.5395 (+22.9%) |

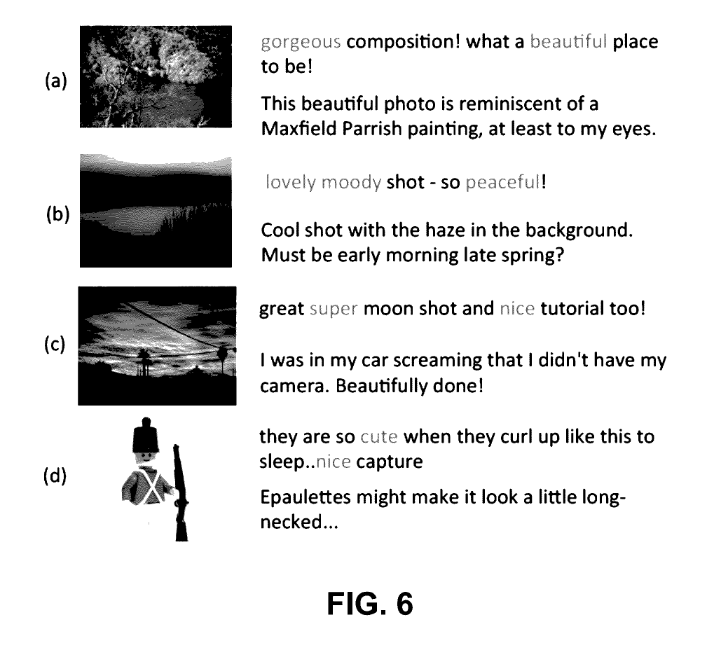

Additionally, as discussed herein, comments associated with the visual content can be considered sparse, and false positives in the predicted VACs can be missing but actually correct. As such, to account for such missing label issues, hit rate, that is, the percentage of the test images that have at least one predicted VAC hitting the ground truth VACs, can be evaluated. Hit rate can be considered similar to overlap ratio but deemphasizes the penalty of false positives in the predicted VACs. As shown for example in Table 5, and as embodied herein, PAC-VAC correlation can achieve 19.0% improvement in overall hit rate compared to PAC only. As further shown in Table 5, and as embodied herein, the gain can increase (22.9%) if the hit rate is computed as the top 3 predicted VACs (hit rate (3)). For purpose of illustration and not limitation, some exemplary prediction results are illustrated in FIGS. 6A-6D. As shown for example in FIGS. 6A-6D, as embodied herein, VACs of “gorgeous” and “beautiful” were predicted for image (a) and VACs of “lovely,” “moody” and “peaceful were predicted for image (b).

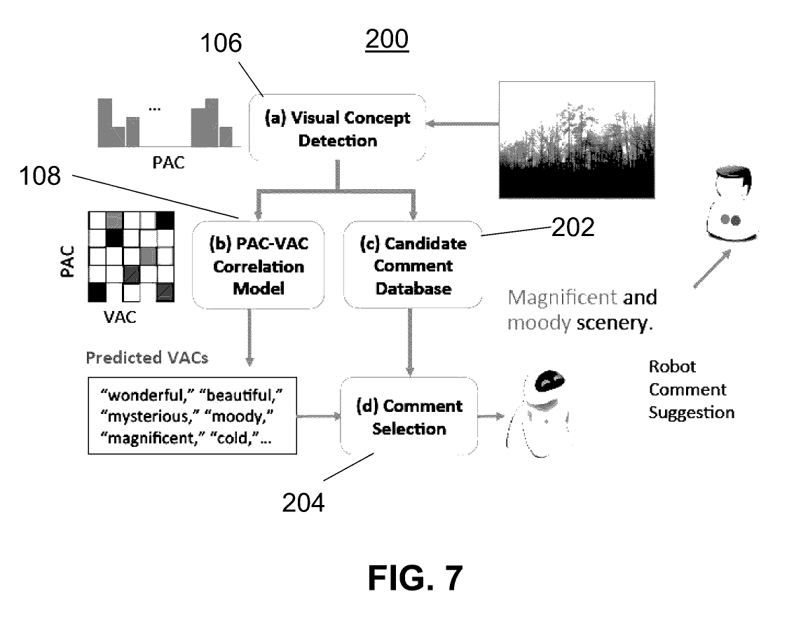

According to other aspects of the disclosed subject matter, techniques for visual sentiment analysis described herein can be utilized to implement a system to generate automated comments in response to visual content. FIG. 7 illustrates an exemplary system for generating automated comments in response to visual content, also referred to herein as assistive comment system 200. Assistive comment system 200 can utilize statistical correlation model between PACs and VACs, as described herein, which can be discovered, for example and without limitation, from training data offline. As discussed herein, for purpose of illustration and not limitation, exemplary visual content and associated metadata (keywords, titles, descriptions) and comments can be obtained from an image hosting social media platform. As shown for example in FIG. 3, and as discussed herein, adjective-noun pairs (for example and without limitation “misty woods”) with sentiment values can be discovered and used as PACs. Such automatic classifiers are available as SentiBank, or any other suitable visual sentiment concept classifier, as discussed further herein. Additionally or alternatively, a pool of comments associated with the visual content, obtained for example from the image hosting social media platform, can be used to mine VACs (for example and without limitation “moody”). Further details about PACs and VACs are described herein. In addition, or as a further alternative, a database of sentence-length comments 202 can be obtained or constructed. For purpose of illustration and not limitation, as embodied herein, the database of sentence-length comments can be synthesized based on a training set of image comments. Each sentence can be synthesized according to conditional word occurrence probabilities estimated from the training set. As such, and as embodied herein, for a new image without any textual keywords or descriptions, concept classifiers, for example from SentiBank, or any other suitable visual sentiment concept classifiers, can be used to detect PACs and generate a concept score vector, whose elements can represent the confidence in detecting corresponding individual concepts (for example and without limitation “misty woods” or “cute dog”). The detected PAC score vector can be input into the statistical correlation model to predict a number of likely VACs to be evoked on a viewer of the image. At 204, the detected PACs and VACs can then be used jointly to select a number of suitable comments from the pre-synthesized database according to systematic criteria, including for example and without limitation, plausibility, relevance, and diversity. The selected comments can be suggested to the user, and the selected comments can be further edited by a user, if desired, before posting to a social media platform.

A viewer response to visual content can be conveyed through one or more sentences. As such, sentence-level comments can be composed of VACs and generated to reflect likely evoked affects of the viewer in response to visual content. In this manner, assistive comment generation can include synthesizing sentence candidates likely to occur from PACs detected in certain visual content, and selecting a set of comments from sentence candidates including the predicted VACs.

For purpose of illustration and not limitation, as embodied herein, generating sentence-level comments for visual content can include text synthesis with consideration of likely VACs elicited by the visual content. Text synthesis can include modeling a sentence using any suitable sentence modeling techniques. For example, and as embodied herein, text synthesis can include modeling a sentence as a Markov chain. For a body of reference text, the probability of occurrence of each word can be determined given the previous words in the same sentence, where a word can be represented as a state. A suitable sentence can thus be generated by starting a word seed and iteratively sampling the following words according to the conditional occurrence probability in the reference text. For example, and as embodied herein, the future state can be determined from the past m states, where the order m can be considered finite and less than the current state. The order m can be chosen as any suitable number, and by increasing the order, a model can be obtained to emulate actual language having relatively fewer grammar errors but can have less flexibility to generate unique sentences as m increases. For purpose of illustration and not limitation, as embodied herein, m can be chosen as 2.

Additionally, for purpose of illustration and not limitation, the reference text can affect the topics of the generated sentences. For example, a reference text including sports news can have a greater probability of generating a sentence related to sports. For purpose of illustration and not limitation, as embodied herein, the generated sentences can be expected to have higher plausibility by using a reference text constructed from images of similar visual content as images being commented on. As such, the comment reference text can be organized by grouping image comments to individual distinct PACs. For purpose of illustration and not limitation, as embodied herein, comments associated with images having the PAC “cute dog” can be grouped to a separate reference text. A Markov chain can modeled by such PAC-specific reference texts, and the generated sentences can be more likely to follow the topics of the comments elicited by the images with the corresponding PACs.

Furthermore, and as embodied herein, a number of pools of sentences, embodied herein as 1200 pools, can be generated in the training stage, each corresponding to a PAC, for example to avoid the online delay in generating PAC-specific reference text. The sentences in each PAC-specific pool can be generated by the reference text of the comments associated with the images containing the specified PAC. As embodied herein, about 40 to 30,000 comments can be associated with each PAC. In the active stage, a subset of sentence pools can be selected to form the candidate sentence pool S without the need to remodel the Markov chain and regenerate sentence candidates. As such, and as embodied herein, the subset of pools can be selected based at least in part on the detection scores of PAC in the analyzed image. Pools corresponding to the top PACs with the highest detection scores can be included.

Automatic PAC detection using visual content classification without utilizing textual metadata can introduce additional challenges. False positives can include a PAC with an incorrect adjective or with an incorrect noun. The generated sentences associated with an incorrect noun can thus include predicted objects absent from the visual content, and thus comments containing such false positive objects can be irrelevant to the image. As such, the confidence score of each noun can be further aggregated, for example to exclude PACs with incorrect nouns, by taking an average of P(pₖ|dⱼ) over all PACs with the same noun. A sentence pool can be selected and added to the candidate database S if its corresponding PAC includes one of the top 5 nouns with the highest aggregate scores.

Additionally, aggregation of confidence scores can be applied to any words in a PAC. For purpose of illustration and not limitation, and as embodied herein, aggregation of confidence scores can be applied to nouns only, rather than adjectives, at least in part because adjectives can be considered more interrelated and subjective than nouns. For purpose of illustration and not limitation, adjectives “happy,” “cute,” “fluffy,” “tiny,” and “adorable” can all be considered valid and highly-related adjectives often used with the noun “dog.” As such, it can be unnecessary or undesirable to exclude some adjectives from others when forming the comment sentence pool.

As discussed herein, a comment can include one or more sentences. With a pool of sentence candidates S for a given test image, a number of appropriate sentences can be selected to form a comment of high quality in terms of a number of criteria, including for example and without limitation, and as embodied herein, relevance and diversity. As such, and as embodied herein, techniques for selecting a single-sentence comment and composing a multi-sentence comment are provided, along with techniques for ranking and suggesting the most appropriate comments.

For purpose of illustration and not limitation, and as embodied herein, the relevance of a sentence to a given image can be measured by the VACs that appear in the sentence and those predicted to be evoked based on the PAC-VAC correlation model described herein. For example, an image can include the PAC “yummy food,” and a sentence containing the VAC “tasty” can be considered to be more relevant than a sentence containing “handsome,” at least in part because “yummy food” can be determined to be more likely to evoke “tasty” rather than “handsome,” as predicted, as embodied herein, by the statistical correlation model. VACs V can be considered to represent the shared attributes to measure the relevance of a sentence to a given image. As embodied herein, the PACs in the given image can be obtained, for example and as embodied herein using SentiBank PAC detectors, or any suitable visual sentiment concept classifiers, and the probability of each VAC evoked by the detected PACs can be predicted, for example and as embodied herein using a Bayes correlation model. The given image dᵢcan be represented as a vector, and each dimension can indicate the probability of evoking a VAC vⱼ. Each sentence s_{q} can be represented by a binary indicator vector B_{q}, and each element B_{qj} can indicate the presence of vⱼ in s_{q}. The relevance between an image dᵢ and a sentence s_{q} can be represented as the likelihood of s_{q} given dᵢ,

p^{(v)}(S_{q}|dᵢ)=Πⱼ₌₁^{|V|}B_{qj}P(vⱼ|dᵢ)+(1−B_{qj})λⱼᵢ (6)

The P(vⱼ|dᵢ) can be estimated by the PAC-VAC correlation model as shown in eq. (4). The first term can compute the inner product of the VAC score vector of the given image dᵢ and the VAC indicator vector of sentence S_{q}. The second term can provide a smoothing term accounting for other VACs not predicted, with its influence affected by the parameter λⱼᵢ. The value of λⱼᵢ can be determined as follows:

$${λ}_{ij} = \frac{γ {\ddot{P}}_{m i n} + ( 1 - γ ) {\ddot{P}}_{ma x} + {\ddot{P}}_{avg}}{2} , \qquad ( 7 )$$

where \ddot{P} can represent the set of probability of VACs in the image dᵢ: dᵢ: {P(vⱼ|dᵢ)|∀vⱼ ∈ V}, and \ddot{P}ₘᵢₙ, \ddot{P}ₘₐₓ and \ddot{P}_{avg} can represent the minimum, maximum and average probability within \ddot{P} respectively. λⱼᵢ can be affected by the relevance indicator γ described in eq. (4). The higher γ can correspond to a lower λⱼᵢ and increased significance of B_{qj} (the presence of vⱼ in s_{q}), and thus the s_{q} that contains vⱼ likely to be evoked by the image content can be favored. γ can be adjusted as desired to improve results, as discussed herein.

A sentence can include plausible VACs together with implausible keywords other than VACs. For purpose of illustration and not limitation, the VAC “funny” can be considered relevant to comment on an image with PAC “cute dog.” However, the sentence “I love the funny cat” can be considered implausible at least because of the mismatched noun “cat” to the image of the “cute dog.” As such, and as embodied herein, the noun nⱼ appearing in the sentence and its probability to appear in the evoked comments for a given image dᵢ can be further considered, for example and without limitation, to reduce or prevent mismatched nouns. For example, a vocabulary with a number of noun concepts can be established, embodied herein using 1000 noun concepts defined as Viewer Noun Concepts (VNC). P(nⱼ|dᵢ) and P(nⱼ|dᵢ) can be measured using techniques described herein to measure P(vⱼdᵢ) and P^{(v)}(s_{q}|dᵢ), where vⱼ can be replaced by nⱼ. The relevance of a sentence to an image can thus be presented as P^{(v)}(s_{q|d}ᵢ) and P⁽ⁿ⁾(s_{q}|dᵢ). The overall relevance score z_{qi} can be measured in the log space by a late fusion manner, represented as

$${z}_{qi} = \frac{log {P}^{( v )} ( {s}_{q} \vert {d}_{i} ) + log {P}^{( n )} ( {s}_{q} \vert {d}_{i} )}{2 {\vert φ ( {s}_{q} ) \vert}^{0.5}} . \qquad ( 8 )$$

[symbol]

(•) can represent the set of words in the given sentence. [symbol] (S_{q}) can represent a normalization term to favor VAC and VNC words in a sentence. As such, the most relevant sentence s_{q} with the highest z_{qi} can be determined as a suggested single-sentence comment to the given image.

Additionally, and as embodied herein, comments can extend beyond a single sentence. A number of sentences p can be chosen from the sentence set Ŝ having the top sentence scores, as discussed herein for example using eq. (8), to form a multi-sentence common set Ĉ. For example and without limitation, and as embodied herein, |Ŝ| can be at least 1, and as embodied herein can be chosen to be 50, and μ can be at least 1, and as embodied herein can be chosen to be 2. A criterion can be utilized to avoid redundancy in combined sentences and/or to ensure a diversity of concepts contained in different sentences in the same comment. For purpose of illustration and not limitation, the comment “I love the funny dog. How cute it is.” can be considered to have more diversity than “I love the funny dog. Very funny.” at least because the first comment includes the VACs “funny” and “cute” while the second comment repeats the same VAC “funny.” The comments in Ĉ can be ranked by the summation of relevance scores, {z_{qi}|∀s_{q}, s_{q} ∈ c_{1}}. The diversity δ₁ (with value ranging between 0 and 1) of a multi-sentence comment C₁ in Ĉ can be measured as follows,

$${δ}_{l} = 1 - \frac{\vert {⋂}_{{s}_{q} ∈ {c}_{l}} {φ}^{′} ( {s}_{q} ) \vert}{\vert {⋃}_{{s}_{q} ∈ {c}_{l}} {φ}^{′} ( {s}_{q} ) \vert} . \qquad ( 9 )$$

φ′(·) can represent the set of VACs and VNCs in the text. The most relevant c₁ in Ĉ with δ₁ larger than a given threshold can be selected as the suggested comment for the given image. For example and without limitation, any suitable threshold can be chosen to increase diversity while reducing the number of available sentences to be suggested for a comment, and as embodied herein, the threshold can be greater than 0, and as embodied herein, can be chosen to be 0.8 and/or can iteratively decrease if no δ₁ satisfies the threshold.

A multiple-sentence comment can include inconsistencies arising from considering diversity. That is, the VACs in different sentences in the same comment can be considered less suitable for use in conjunction in the same comment. For example and without limitation, “I love the funny dog. It looks so scary.” can be unsuitable, as the VACs “funny” and “scary” can be determined to rarely co-occur in the same comment for an image. As such, the 2^{nd} and later sentences in a comment can be further chosen to be sentences generated by the reference text, as discussed herein, sharing the same PAC nouns as the reference text used in generating the first sentence. In this manner, all sentences in the same comment can be generated from a reference text related to the same PAC noun, and thus inconsistency among sentences can be reduced or eliminated.

Furthermore, and as embodied herein, the techniques described herein can be extended to multi-comment suggestion to provide additional options for users. For example, and as embodied herein, an additional comment can be iteratively chosen to add unique information compared to comments already provided, which can be used to provide comments relating to time-based events. For purpose of illustration and not limitation, as embodied herein, in each iteration, a new comment c* can be selected from the comment set Ĉ^{(r-1)}, where c* can be chosen having the fewest VACs and VNCs overlapped by the set of suggested comments [symbol] ^{(r-1)} in the previous iteration τ−1.

$${c}^{*} = {arg min}_{{c}_{l} ∈ {\hat{C}}^{( τ - 1 )}} \frac{\vert {φ}^{′} ( {Ω}^{( τ - 1 )} ) ⋂ {φ}^{′} ( {c}_{l} ) \vert}{\vert {φ}^{′} ( {Ω}^{( τ - 1 )} ) ⋃ {φ}^{′} ( {c}_{l} ) \vert} . \qquad ( 10 )$$

For example and as embodied herein, the new set of suggested comments Ω^{(r)} can be updated as Ω^{(r-1)} U c* and the set of candidate comments Ĉ^{(r)} can be updated as Ĉ^{(r-1)}−c*. The initial comment in Ω can follow the criteria described herein with respect to single comment selection, and each latter comment can be selected to satisfy diversity described herein with respect to a single comment.

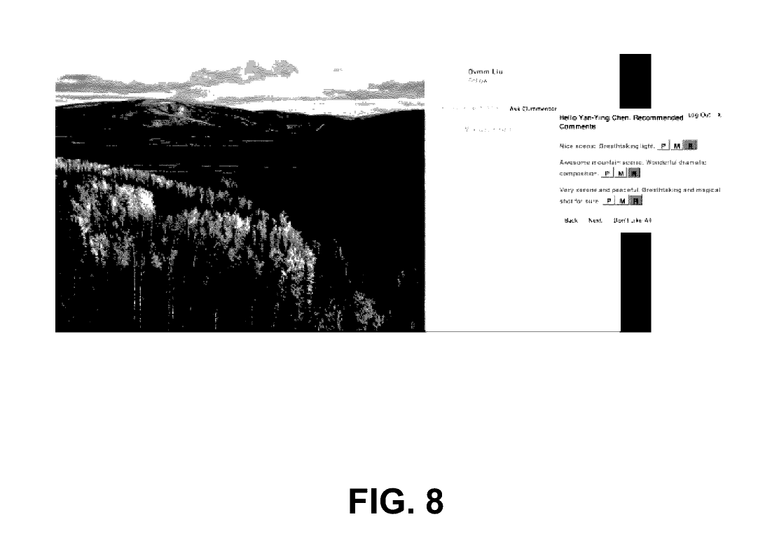

The assistive comment system 200 can be configured as a tool to allow users to comment on photos more efficiently. For example, and as embodied herein, assistive comment system 200 can recommend one or more plausible comments relevant to visual content. Additionally, if desired, a user can select any comment based on their own preference. For purpose of illustration and not limitation, assistive comment system 200 can be implemented as a software application, for example and as embodied herein, as an extension tool for a web browser application. FIG. 8 illustrates an exemplary user interface for assistive comment system 200. An image 250 can be selected, and assistive comment system 200 can suggest a number of comments 252, as embodied herein suggesting three comments, and can include functions to assist users in finding preferred comments more efficiently, as discussed herein.

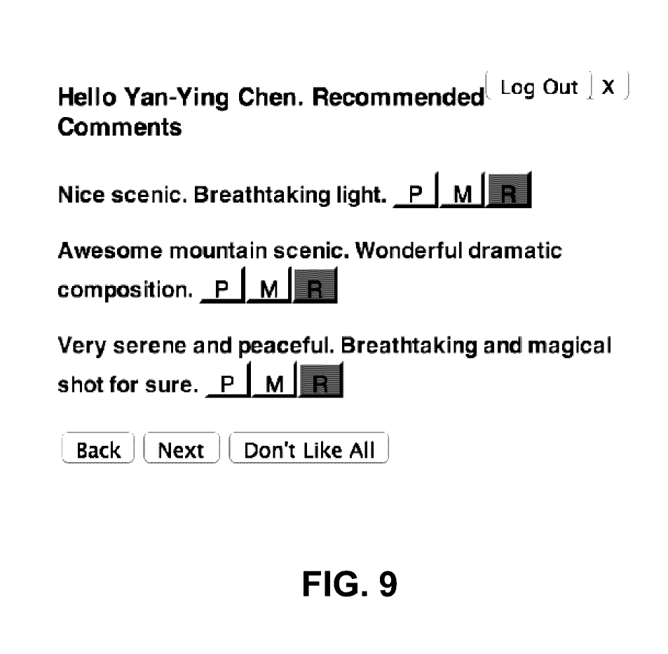

FIG. 9 shows an enlarged view of the comment portion of the user interface of FIG. 8. For purpose of illustration and not limitation, as embodied herein, buttons “Back” and “Next” can be configured to return to the comments displayed in a previous iteration and to request more comments in a next iteration, respectively. For example, as embodied herein, the “Next” button can be selected, and the comments displayed in the current iteration can be logged as displayed but not selected comments in a database. A button “Don't Like All” can be configured to allow the user to indicate that all displayed comments in the current iteration are not satisfactory, and such comments can be logged as rejected comments in the database.

Referring to FIG. 9, buttons “R” (red) and “M” (blue) in can be configured to obtaining user feedback for each comment. Selecting button “R” can allow the user to indicate a rejection of the corresponding comment, which can be logged in the database as a rejected comment. Selecting button “M” can allow the user to request additional comments (for example, embodied herein as three more comments) related to the corresponding comment, and additionally or alternatively, the comment can be logged in the database as a preferred comment. Button “P” (green) can allow the user to select the corresponding comment for posting, and additionally or alternatively, the comment can be logged as a posted comment and/or submitted to a social media platform for posting to the visual content.

Additionally, and as embodied herein, referring to FIG. 9, button “x” can cancel a current session of comment suggestion without saving any logs. Tooltips can be provided, such that when a user's cursor moves proximate a buttons, a description of the button can be provided to the user.

Furthermore, and as embodied herein, the user interaction logs described herein can be used as informative relevance feedback to further improve comment suggestion. For purpose of illustration and not limitation, each type of the comment log can affect updating the results of VAC prediction and subsequent comment suggestions. For example, and as embodied herein, an image can be provided, and predicted probabilities of VACs P(vⱼ|dᵢ;θ) and VNCs P(nⱼ|dᵢ;θ) of the image can be adjusted based on the history of comments previously shown to the user and corresponding feedback received from the user.

$${P}^{′} ( {v}_{j} \vert {d}_{i} ) = ( 1 - {ρ}_{ji} ) P ( {v}_{j} \vert {d}_{i} ; θ ) + {ρ}_{ji} {\ddot{P}}_{m i n} , \\ {ρ}_{ji} = max ( {\sum }_{{c}_{l} ∈ {C}^{( {v}_{j} , {d}_{i} )}}^{ } σ ( {c}_{l} ) , 1 ) . \qquad ( 11 )$$

Where \ddot{P}ₘᵢₙ can represent a minimal value of P(vⱼ|dᵢ,θ) over vⱼ. ρ_{j,i} can represent an aggregated penalty incurred by the logs in C^{(v}^{ⱼ}^{, d}^{ᵢ}⁾ which can be determined as the union of rejected comments and displayed but not selected comments of image dᵢ that contain vⱼ. σ(•) can represent an adjustable controlled penalty. In this manner, a concept can be determined to be contained in more comments that have been rejected or not selected, and thus the predicted probability of the concept can be reduced and/or shifted towards the minimal value \ddot{P}ₘᵢₙ.

Additionally or alternatively, comment suggestion can be further personalized. For example, and as embodied herein, a penalty value of σ(•) can be initially set to 0.1 and can be increased up to 1 in subsequent iterations of the same image and user. In addition, or as a further alternative, vⱼ can appear in the “preferred comments,” and P′(vⱼ|dᵢ) can be set to \ddot{P}ₘₐₓ, which can indicate vⱼ has a highest probability to be included in the following suggested comments.

### EXAMPLE 1

For purpose of illustration and confirmation of the disclosed subject matter, 26 users of a social media platform utilized the assistive comment system 200. The users included 8 females and 18 males, each aged between about 20-35. Most users were graduate students majoring in computer science or a related field. The users were not made aware of the technical details.

The users were provided a set of test images with 7 topical categories: flower, architecture, scenery, human, vehicle and animal, each set including 20 images. The 7 image categories were selected to represent popular topics in consumer photos commonly appearing in social media. The images in each category were randomly sampled from Creative Common Licensed photos made publicly available on the website http://www.public-domain-image.com.

The users were asked to consider the photos were posted by their friends on a social media platform and to post comments accordingly. Each user was asked to comment on three images in each topical category by selecting from comments suggested by assistive comment system 200 and another three images without using the system. The former are referred to herein as machine-assisted comments (machine), and the latter are referred to herein as manually-created comments (manual). The term “machine suggested comment” is used herein to refer to comments suggested by assistive comment system 200 for a new image. Such suggested comments were presented to the user, and the user was instructed to select any of the suggested comments and post them on the social medial platform. The term “machine assisted comments” is used herein to refer to such selected comments. The users then evaluated the quality of such “machine assisted comments.” While the assistive comment system 200 suggested several comments for an image, typically only a subset of the comments were selected and accepted by the user.

For purpose of illustration and confirmation of the disclosed subject matter, in this example, the number of sentences μ per comment, as discussed herein, was set to 2, which can be suitable to obtain machine generated comments of similar lengths to those for manually generated comments (for example and as embodied herein, on average 6.1 words compared 5.5 words per comment, respectively). Assistive comment system 200 can generating longer comments with more sentences by adjusting the parameter, as described herein. For purpose of illustration, more grammar errors can exist in longer comments than shorter comments, and grammar verification can be used to improve the quality of comments.

The machine-assisted comments and the manually-created comments were mixed in the display on the social media page after they were posted. In this manner, there was no indication which comments were generated using assistive comment system 200. The users reviewed the posted comments and indicated on the social media page which comments they like while interacting with the images on the social media page.

### EXAMPLE 2

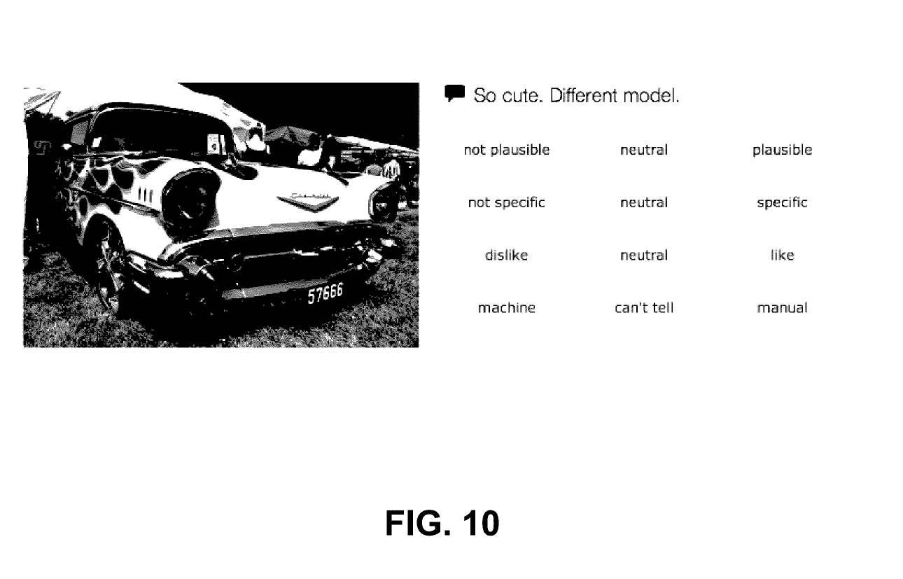

For purpose of illustration and confirmation of the disclosed subject matter, another 10 users were asked to evaluate the quality of the machine-assisted comments (selected by the users) and manually-created comments generated in Example 1. FIG. 10 illustrates an exemplary user interface for evaluating the quality of the comments generated in Example 1. With reference to FIG. 10, each evaluation includes an image and a single comment, either machine-assisted or manually-created. The users were asked to evaluate the comment in terms of (1) plausibility (e.g., how plausible the comment is to the given image), (2) specificity (e.g., whether the comment is specific to the given image content or generic, (3) preference (e.g., how much the user likes the given comment) and (4) realism (e.g., whether the user can determine if the comment was machine-assisted). Each of the 140 test image-comment pairs was evaluated by three users, for a total of 420 evaluation results.

Referring again to Example 1, the users contributed 405 test sessions. Each test session was finished either by posting a selected comment or by rejecting all suggested comments. With reference to Table 6, on average the users finished a session within 3.43 iterations, each iteration including 3 suggested comments. The # posts refers to the number of sessions in which the users accepted one of the suggested comments and selected it for posting. As shown in Table 6, the acceptance rate of comments was up to 98%. In the Example, among the 7 image classes, the acceptance rate of the classes “flowers” and “scenery” were the highest. Both classes include outdoor scenes or close-up objects that can occupy the whole image, which can result in improved accuracy of PAC detection from visual content. For example and not limitation, as embodied herein, PAC detection can utilize visual features of the image as a whole. Additionally or alternatively, PAC detection can utilize visual features of localized objects identified in the image. With reference to Table 6, in this example, the class “human” had the lowest acceptance rate (81%), which can indicate commenting on images with human subjects can benefit from increased familiarity with the subjects.

TABLE 6
Evaluation of Assistive Comment System for Suggesting Social
Comments for Images

| image class | food | flowers | architecture | scenery | human | vehicle | animal | all |
|---|---|---|---|---|---|---|---|---|
| # sessions | 50 | 52 | 60 | 51 | 57 | 74 | 60 | 405 |
| # posts | 45 | 51 | 53 | 50 | 47 | 63 | 54 | 363 |
| # iterations | 2.36 | 2.58 | 3.15 | 2.29 | 3.48 | 3.99 | 5.57 | 3.43 |
| # clicks (next) | 1.68 | 2.17 | 2.69 | 1.94 | 2.90 | 3.47 | 5.00 | 2.92 |
| # clicks (more) | 0.68 | 0.40 | 0.46 | 0.35 | 0.59 | 0.51 | 0.57 | 0.51 |
| # clicks (reject) | 1.56 | 0.71 | 2.20 | 0.29 | 2.24 | 2 | 2.83 | 1.75 |
| accept rate | 0.90 | 0.98 | 0.88 | 0.98 | 0.81 | 0.85 | 0.90 | 0.90 |

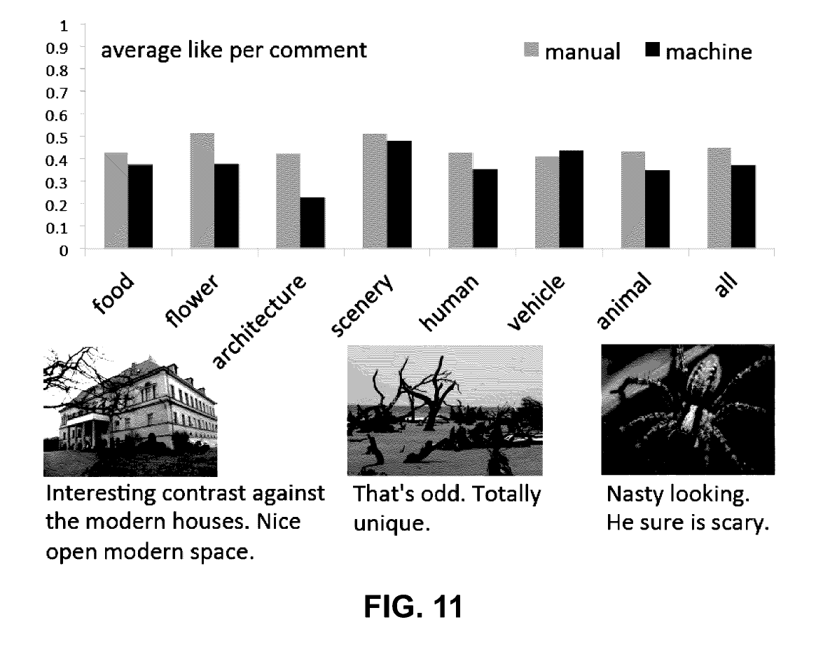

For purpose of illustration and confirmation of the disclosed subject matter, a comparison of preferences between manually-comments and machine-assisted comments can be evaluated. The number of “likes” a comment receives on a social media platform can be an intuitive indicator of preference. FIGS. 11A-11D illustrates the average number of likes per machine-assisted/manually-created comment in each photo class, as discussed above with respect to Example 2. As shown in FIGS. 11A-11D, in Example 2, the average “like” of machine-assisted comments was 0.37, which was lower than that of manually-created comments at 0.45. The results are similar in the comments for images of different classes.

In Example 1, in some sessions, users used the “x” button (as shown for example in FIG. 9) to cancel commenting without accepting any suggested comment or explicitly rejecting all suggested comments. Through additional survey, the users indicated lack of strong evaluations of the suggested comments. Users in some cases found the suggested comments reasonable but desired to look for more suitable comments by canceling the session and starting a new again.

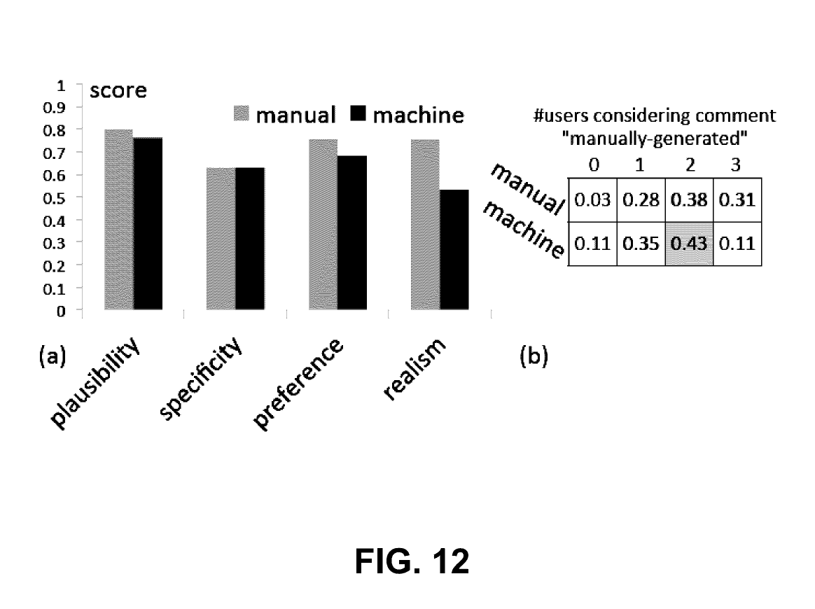

For purpose of illustration and confirmation of the disclosed subject matter, in Example 2, the quality of the comments produced by humans with or without the assistive comment system (e.g., machine vs. manual) were evaluated. Three degrees of each quality metric (as shown for example in FIG. 10) were given different scores, 0, 0.5 and 1, from left to right. For each metric, the score of each image-comment pair was computed as the average of the scores given by three subjects. FIGS. 12A-12B together illustrate the average scores of the four quality metrics, e.g., plausibility, specificity, preference and realism. As such, the preference is different from that measured by the “likes” illustrated in FIGS. 11A-11D.

As illustrated in FIG. 12A, among the four evaluation metrics, the manually-created comments and machine-assisted comments had nearly the same specificity and less than 5% difference in plausibility. The difference in realism is larger than the other three metrics, which is further illustrated in FIG. 12B. FIG. 12B illustrates a number of users who correctly determined whether the given comment was machine-assisted or manually-generated. More than 50% (0.43+0.11) of machine-generated comments were incorrectly determined to be manually-generated by the majority of the users (e.g., at least 2 of the 3 users in a particular evaluation). As such, the machine-assisted comments can be convincing in resembling manually-created comments.

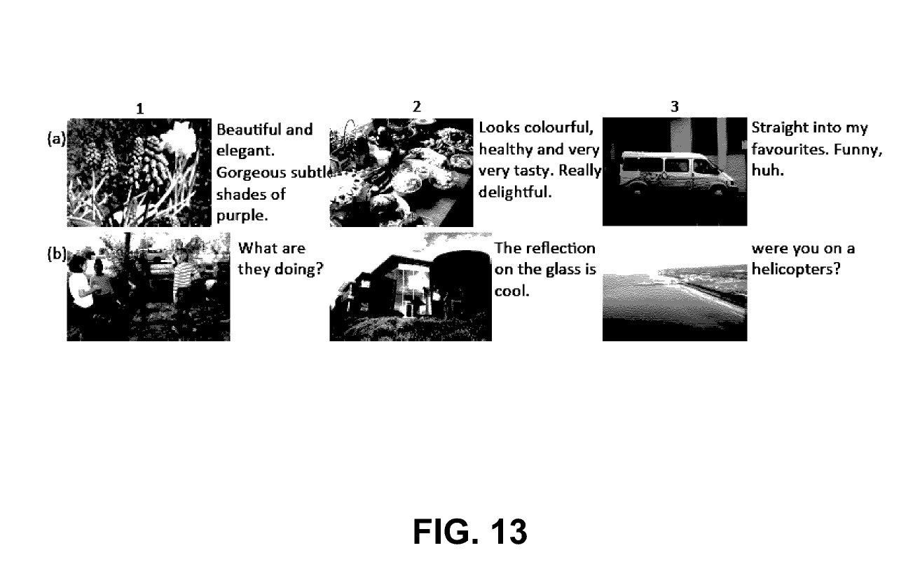

FIGS. 13A-13F illustrates exemplary image-comment pairs that were considered to be “real” (i.e., manually-created) by all three users in an evaluation. The comments in the upper bar were machine-assisted and those in the lower bar were manually-created. All of the comments were found to have high plausibility and some of them mention particular details in the given image (e.g., FIG. 13A and FIG. 13E. Several comments considered as manually-created included question sentences, e.g., FIG. 13D and FIG. 13F, which can provide an additional style of comment that can be implemented in assistive comment system 200.

For purpose of illustration, as shown in Table 7, the score of realism had positive correlations with all the three metrics, and the highest correlation with “preference.” That is, the users can tend to dislike a comment if they perceive it as machine-generated. As such, while the users can differentiate machine-assisted comments from the manually-created ones considerably well (for example, and as embodied herein, 69% of real comments were determined to be generated manually, while 54% of the machine-assisted comments were determined to be generated manually), the disparity can be reduced in real applications where such differences are not proactively being investigated.

TABLE 7
Pearson's Coefficient r of Realism Compared to the Other Three Metrics

| Pearson's r | plausibility | specificity | preference |
|---|---|---|---|
| realism | 0.3126 | 0.3871 | 0.4579 |

For purpose of illustration and confirmation of the disclosed subject matter, components of the visual sentiment analysis techniques described herein can be evaluated. Table 8 illustrates top PAC-VAC correlated pairs ranked by P(pₖ|vⱼ) (see eq. (1)) and filtered by statistical significance value (p-value), for example and without limitation, “hilarious” for “crazy cat,” “delicate” for “pretty flower” and “hungry” for “sweet cake.” With reference to Table 8, some adjectives in the PACs and VACs can be different, for example and without limitation, “cute” for “weird dog” and “scary” for “happy Halloween.”

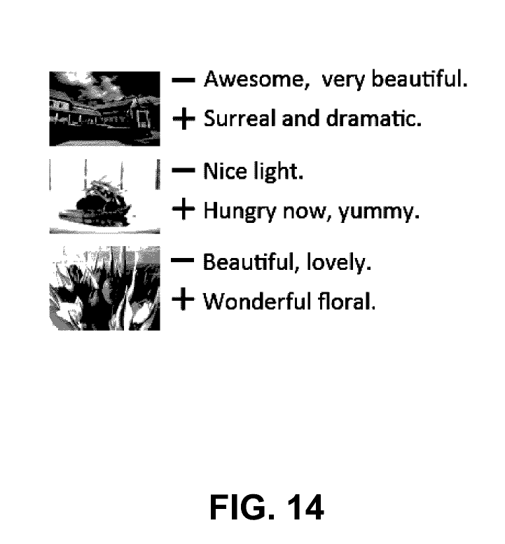

Additionally, and as discussed further herein, the assistive comment system 200 can consider the relevance between a sentence and the given image content as well as the diversity among a plurality of sentences in a comment. FIGS. 14A-14C illustrates exemplary affects of relevance indicator γ (see eqs. (4) and (6)). As illustrated for example and without limitation in FIGS. 14A-14C, increasing γ can provide selection of more content-relevant sentences (e.g., illustrated as (+), γ=1) for a given image while decreasing γ can provide selection of more generic sentences (e.g., illustrated as (−), γ=0.1), though both are plausible.

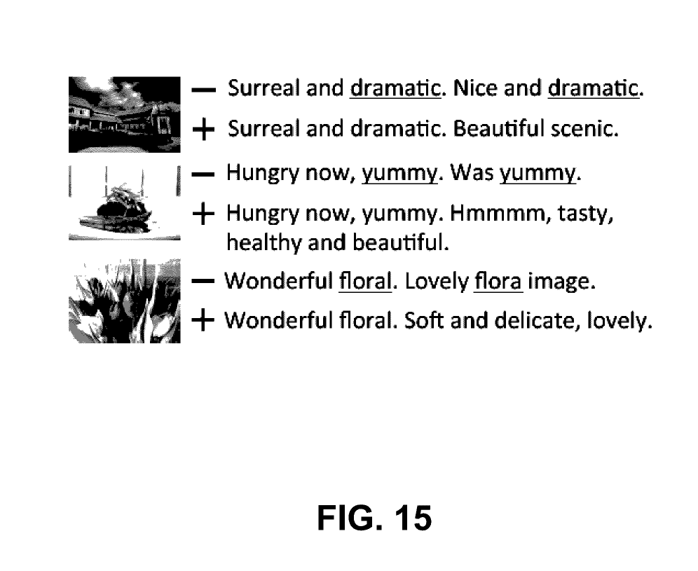

Furthermore, and as embodied herein, FIGS. 15A-15C illustrates generated comments with and without accounting for diversity, as discussed further herein, for example and without limitation, with respect to eq. (9). As shown for example and without limitation in FIGS. 15A-15C, comments generated without and with accounting for diversity, as discussed herein are shown in 15A-15C and indicated as (−) and (+), respectively. For purpose of illustration and not limitation, as embodied herein, certain repetitive VAC words (underlined) can appear in the comments generated without considering diversity, e.g., “dramatic,” “yummy” and “floral” in the comments of (−). For purpose of comparison, as embodied herein, compared with the comments composed with the consideration of diversity (+), the comments of (−) can present redundant information, which can be considered to decrease the quality. Increasing relevance and diversity can be considered to enrich the information in a comment. However, the subjective quality of the comment can still be affected by the personal and social context.

As discussed further herein, assistive comment system 200 can include functions to gather relevance feedback from users including requesting more comments related to a generated comment (embodied herein using button “M” as discussed herein) and rejecting a generated comment. In Example 1, with reference to Table 3, “M” (# more) and “R” (# reject) were clicked an average of 0.51 and 1.75 times per session, respectively, before a user accepted a comment. As such, some comments can particularly interest users or look implausible to users. Such relevance feedback can be used to further improve the performance. Additionally or alternatively, as embodied herein, the function “Next” can also be used to indicate relevance feedback. As shown for example and without limitation in eq. (4), the “Next” function can be used to iteratively reduce the probabilities of VACs that have appeared in the comments of the previous iterations. For purpose of illustration and not limitation, in Example 1, the users made a post after clicking “Next” an average of 2.92 times. As such, utilizing such relevance feedback can improve the comment suggestions of assistive comment system 200.

Although various implementations and applications of visual sentiment analysis are described herein, the systems and methods herein can be used for a wide-variety of applications, including and not limited to, product reviews, news stories, film critiques and advertising. The image data sets, frequent concepts, user types, and user behaviors can be varied and the tools and models described herein need to be updated or adapted for use with any suitable applications. Additionally or alternatively, the systems and techniques described herein can be extended to more diverse sentence types, e.g., question sentences, for example and without limitation, by collecting reference text for additional sentence types. The systems and techniques described herein, for example and without limitation, for concept discovery, correlation modeling and/or comment recommendation can thus be generalized.

Additionally or alternatively, the systems and techniques described herein can be implemented to consider variations among individual users, for example and without limitations, including demographics, interests and/or other attributes. Such personalized factors can be used, for example and without limitation, to improve modeling correlation between image content and viewer affects and customizing the preferred comments in response to shared images.

In addition, or as a further alternative, evoked viewer affects can be influenced by context in which the image is shared and/or social relations between the publisher and the viewers. Similar image content can evoke different affective responses when presented in different social or cultural contexts or embedded in different conversation threads. Additionally or alternatively, responses of individual users can be influenced by certain opinion leaders in the community.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A method for determining one or more viewer affects evoked from visual content using visual sentiment analysis using a correlation model including a plurality of publisher affect concepts correlated with a plurality of viewer affect concepts, comprising:
detecting, by a processor in communication with the correlation model, one or more of the plurality of publisher affect concepts present in selected visual content; and
determining, by the processor using the correlation model, one or more of the plurality of viewer affect concepts corresponding to the one or more of the detected publisher affect concepts.

2. The method of claim 1, further comprising providing the correlation model, wherein the correlation model comprises a Bayes model to characterize correlations between the plurality of publisher affect concepts and the plurality of viewer affect concepts.

3. The method of claim 2, wherein providing the correlation model further comprises smoothing the correlation model using collaborative filtering.

4. The method of claim 1, further comprising obtaining the plurality of publisher affect concepts, wherein the plurality of publisher affect concepts are obtained from metadata associated with visual content in a visual content database.

5. The method of claim 1, further comprising obtaining the plurality of publisher affect concepts, wherein the plurality of publisher affect concepts are obtained from visual analysis of visual content in a visual content database.

6. The method of claim 1, further comprising obtaining the plurality of viewer affect concepts, wherein the plurality of viewer affect concepts are obtained from social media comment data associated with visual content on a social visual content platform.

7. The method of claim 1, further comprising generating one or more comments corresponding to the selected visual content based on the one or more determined viewer affect concepts.

8. The method of claim 7, wherein generating the one or more comments further comprises forming one or more sentences using a relevance criterion of the one or more sentences with respect to the selected visual content.

9. The method of claim 7, wherein generating the one or more comments further comprises forming a plurality of sentences using a diversity criteria of a first sentence of the plurality of sentences compared to a subsequent sentence of the plurality of sentences.

10. The method of claim 7, further comprising posting the one or more comments to a social media platform associated with the selected visual content.

11. A method for determining one or more visual content to evoke one or more viewer affects using visual sentiment analysis using a correlation model including a plurality of publisher affect concepts correlated with a plurality of viewer affect concepts, comprising:
receiving, by a processor, one or more target viewer affect concepts of the plurality of viewer affect concepts;
determining, by the processor using the correlation model, one or more of the plurality of publisher affect concepts correlated with the one or more target viewer affect concepts;
selecting, by the processor in communication with a visual content database, one or more visual content corresponding to the one or more determined publisher affect concepts; and
outputting, by the processor in communication with a display, the one or more visual content to the display.

12. The method of claim 11, further comprising providing the correlation model, wherein the correlation model comprises a Bayes model to characterize correlations between the plurality of publisher affect concepts and the plurality of viewer affect concepts.

13. The method of claim 12, wherein providing the correlation model further comprises smoothing the correlation model using collaborative filtering.

14. The method of claim 11, further comprising obtaining the plurality of publisher affect concepts, wherein the plurality of publisher affect concepts are obtained from metadata associated with visual content in a visual content database.

15. The method of claim 11, further comprising obtaining the plurality of publisher affect concepts, wherein the plurality of publisher affect concepts are obtained from visual analysis of visual content in a visual content database.

16. The method of claim 11, further comprising obtaining the plurality of viewer affect concepts, wherein the plurality of viewer affect concepts are obtained from social media comment data associated with visual content on a social visual content platform.

17. The method of claim 11, further comprising ranking the one or more visual content in order of likelihood of evoking the one or more target viewer affect concepts.
